(19) United States
(12) Patent Application Publication
(10) Pub. No.: US 2009/0090007 A1
(43) Pub. Date: Apr. 9, 2009

(54) Method of manufacturing gear from metal sheet and the gear manufactured by the method

(75) Inventors: Masahiro Takada, Okazaki-shi (JP); Shigenari Takigiri, Kariya-shi (JP); Tetsuo Ono, Handa-shi (JP)

Correspondence Address: OLIFF & BERRIDGE, PLC, P.O. BOX 320850, ALEXANDRIA, VA, 22320-4850, US

(73) Assignee: DENSO CORPORATION, Kariya-City (JP)

(21) Appl. No.: 12/285,353

(22) Filed: Oct. 2, 2008

(30) Foreign Application Priority Data
Oct. 3, 2007 (JP) 2007-259758

(51) Int. Cl. B23P 15/14; F16H 55/00

(52) U.S. Cl. 29/893.1; 74/462

(57) ABSTRACT

A gear is manufactured in a half blanking stage, a punching stage and a separating stage. In the half blanking stage, half blanking is performed for a columnar portion of a metal sheet. A part of an outer circumferential surface of the blank is disconnected from the other portion of the sheet, while the other part of the outer circumferential surface of the blank is connected with the other portion of the sheet. In the punching stage, an inner portion of the blank is punched in a punching direction to form teeth on an inner circumferential surface of the blank. In the separating stage, the blank is separated from the other portion of the sheet as a gear toward a separation direction opposite to the punching direction by disconnecting the other part of the outer circumferential surface of the blank from the other portion of the sheet.

### CROSS-REFERENCE TO RELATED APPLICATION

This application is based upon and claims the benefit of priority of the prior Japanese Patent Application 2007-259758 filed on Oct. 3, 2007, so that the contents of which are incorporated herein by reference.

### BACKGROUND OF THE INVENTION

1. Field of the Invention

The present invention relates generally to a method of manufacturing a gear from a metal sheet, and more particularly to the method of manufacturing the gear in stages of producing a blank from the metal sheet, forming a tooth profile on an inner or outer circumferential surface of the blank and cutting off the blank as the gear from the metal sheet. The present invention also relates to the gear manufactured by the method.

2. Description of Related Art

To start the driving operation of an engine mounted in a vehicle, a starter is used to transmit a rotational force produced in a motor to the engine while reducing the rotational speed of the force. For example, a rotational speed reducing type starter is disclosed in Published Japanese Patent First Publication No. 2005-113816. This starter has a multiple disc type impact absorbing device for preventing transmissions of excessive torques produced in an engine. This impact absorbing device has an internal gear meshing with a plurality of planet gears to reduce the rotational speed of a rotational force produced in a motor of the starter.

This internal gear is divided into a plurality of ring-shaped rotary discs. Each rotary disc is placed between two fixed discs disposed in the thickness direction of the rotary disc. The side surfaces of the rotary disc are in contact with side surfaces of the fixed discs. When the rotary disc receives a rotational force of a motor, the rotation of the rotary disc is restricted due to frictions with the fixed discs. Therefore, the device reduces the rotational speed of the rotational force and transmits the rotational force to an engine to start the driving operation of the engine. In contrast, when a torque exceeding a sliding torque of the rotary discs is applied to the internal gear from the engine, each rotary disc is slid or rotated on the fixed discs against the frictional resistance with the fixed discs. Therefore, the internal gear is rotated in response to the excessive torque, so that the internal gear prevents the transmission of the excessive torque.

Each rotary disc formed in the ring shape has gear teeth on the inner circumferential surface of the rotary disc. The gear teeth of the rotary discs form gear teeth of the internal gear. As an example, the rotary discs are manufactured by using a progressive die type press. This press has dies and punches, and a long metal sheet is fed to the press. The press successively blanks out rotary discs from the metal sheet.

FIG. 1 is a top view of a long metal sheet fed to a press to show stages in a method of manufacturing rotary discs.

As shown in FIG. 1, at a first stage, a press (not shown) punches a first portion 110a of a long metal sheet 110 fed to the press to form a hole and to form a tooth profile 120 facing the hole in the sheet 110. More specifically, the press has a pair of first die and punch (not shown) formed in an inner shape of a rotary disc. The first punch of the press is moved down to cut off the first portion 110a from the sheet 110 supported by the first die. Therefore, the tooth profile 120 is formed in the sheet 110.

At a second stage, the press blanks out a second portion of metal sheet 110 as a rotary disc 100. More specifically, the press has a pair of second die and punch (not shown) formed in an outer shape 130 of the disc. The second punch of the press is moved down in the same direction as that of the first punch to cut off the second portion from the sheet 110. In this press working, the rotary disc 100 receives a shearing force from the second punch. Therefore, the rotary disc 100 blanked out has gear teeth formed in the tooth profile 120 on the inner circumferential surface of the disc.

In this manufacturing method shown in FIG. 1, when the rotary disc 100 is cut off from the sheet 110, the rotary disc 100 is easily warped by the received shearing force. Because a frictional resistance between the rotary disc and the fixed disc is necessary, the rotary disc should be in face contact with the fixed disc. However, because the warped rotary disc 100 is not flattened with high precision, frictional resistances cannot be sufficiently obtained in the internal gear having the rotary discs 100 and fixed discs.

Further, because the rotary disc 100 is warped, the gear teeth of the rotary disc 100 are distorted. Therefore, the gear teeth are not formed with a high precision. In this case, when the internal gear meshes with planet gears, a contact surface between the internal gear and each planet gear has an insufficient area. Therefore, when the internal gear transmits a rotating torque as a speed reducing device, excessive gear noise is produced, or a portion of the tooth flank of the internal or planet gear is undesirably broken.

Moreover, in the manufacturing method using the progressive die type press, first burrs are formed on the inner circumferential surface of the rotary disc 100 in the first stage, and the first burrs are protruded toward the moving direction of the first punch. Further, second burrs are formed on the outer circumferential surface of the rotary disc 100 in the second stage, and the second burrs are protruded toward a direction opposite to the moving direction of the second punch. Because the first and second punches are moved down in the same moving direction, the extending direction of the first burrs is opposite to the extending direction of the second burrs. That is, the side surface of the rotary disc 100 having the first burrs differs from the side surface of the rotary disc 100 having the second burrs.

FIG. 2A is a sectional view of a part of one rotary disc with burrs just placed between two fixed discs, while FIG. 2B is a sectional view of a part of one rotary disc after the break-in rotation for the rotary disc placed between two fixed discs. The view of the rotary disc 100 in each of FIG. 2A and FIG. 2B is obtained by enlarging a portion D shown in FIG. 1.

As shown in FIG. 2A, when each rotary disc 100 is just placed between two fixed discs 200 to assemble the discs 100 into the internal gear, burrs 140a formed on the inner circumferential surface of disc 100 extend from one side surface of the rotary disc 100 toward one fixed disc 200, and burrs 140b formed on the outer circumferential surface of disc 100 extend from the other side surface of the rotary disc 100 toward the other fixed disc 200. Therefore, the whole side surface of the rotary disc 100 is not in contact with the side surface of any fixed disc 200, but the side surfaces of the discs 100 and 200 are partially in contact with each other. As shown in FIG. 2B, when the break-in rotation is performed for the rotary disc 100 placed between the fixed discs 200, the burrs 140a and 140b are shortened. However, because the side surfaces of the discs 100 and 200 are partially in contact with each other during the break-in rotation, the contact strength of the burrs 140a and 140b with the discs 200 is weakened. Therefore, the burrs 140a and 140b inevitably remain on the discs 200. In this case, all side surfaces of the discs 100 and 200 are not sufficiently in contact with each other, and an opening formed between the side surfaces of the discs 100 and 200 still remains. As a result, the discs 100 and 200 are not sufficiently attached to each other, so that the frictional resistance between the discs 100 and 200 is insufficient.

To solve these problems, the rotary disc 100 formed in the press is flattened by applying external forces to warped portions of the disc 100, and the burrs 140 of the disc 100 are cut off. However, dents and shear droop are inevitably formed on the tooth flanks of the teeth of the disc 100. Therefore, the meshing performance of the internal gear having the rotary discs 100 is degraded. Further, it is troublesome to flatten the rotary discs 100. Therefore, the productivity of discs 100 is degraded, and the manufacturing cost of discs 100 is increased.

### SUMMARY OF THE INVENTION

An object of the present invention is to provide, with due consideration to the drawbacks of the conventional manufacturing method, a gear manufacturing method wherein a gear superior in the meshing performance is easily manufactured at a high flatness from a metal sheet without a process for removing burrs formed in the gear.

The object of the present invention is also to provide a gear manufactured by the method.

According to a first aspect of this invention, the object is achieved by the provision of a method of manufacturing a gear in a half blanking stage, a punching stage and a separating stage performed in that order. In the half blanking stage, half blanking is performed for a first portion of a metal sheet to produce a blank with an outer circumferential surface facing a second portion of the metal sheet from the first portion of the metal sheet and to form a first profile on the outer circumferential surface of the blank. A part of the outer circumferential surface of the blank is disconnected from the second portion of the metal sheet, while the other part of the outer circumferential surface of the blank is connected with the second portion of the metal sheet. In the punching stage, an inner portion of the blank is punched in a punching direction to form an inner circumferential surface of the blank and to form the inner circumferential surface of the blank in a second profile. At least one of the first and second profiles is a profile of a plurality of teeth to form the blank having the teeth on its inner or outer circumferential surface. In the separating stage, the blank is separated from the second portion of the metal sheet as the gear toward a separation direction opposite to the punching direction by disconnecting the other part of the outer circumferential surface of the blank from the second portion of the metal sheet.

With these stages of the method, in the separating stage, the blank having one part of the outer circumferential surface already disconnected from the metal sheet is separated from the metal sheet by disconnecting the other part of the outer circumferential surface of the blank from the metal sheet. In this separation, the blank receives a shearing force. However, this shearing force is small as compared with that received in a blank fully connected with the metal sheet when the blank is disconnected from the metal sheet.

Accordingly, because the shearing force received in the blank is small, the gear can have a high flatness without being substantially warped, and burrs formed on the outer circumferential surface of the blank during the separation can become small. Further, because the gear is not substantially warped, the teeth can be formed on the inner or outer circumferential surface of the blank with a high precision.

Further, the separation direction in the separating stage is opposite to the punching direction in the punching stage. Therefore, burrs formed on the inner circumferential surface of the blank in the punching stage and burrs formed on the outer circumferential surface of the blank in the separating stage are placed on the same side surface of the blank. When the side surface of the gear having the burrs is put on a side surface of a fixed disc to perform a break-in rotation of the gear on the side surface of the fixed disc, only the burrs stand on the side surface of the fixed disc. Therefore, after the break-in rotation, the burrs can be smoothly sunk into the fixed disc.

Accordingly, this method can reliably manufacture a gear superior in the meshing performance at a high flatness without any process for removing the burrs.

According to a second aspect of this invention, the object is achieved by the provision of a method of manufacturing a gear in a half blanking stage and a separating stage performed in that order. In the half blanking stage, half blanking is performed for a first portion of a metal sheet to produce a blank with an outer circumferential surface and an inner circumferential surface from the first portion of the metal sheet and to form a tooth profile on at least one of the inner and outer circumferential surfaces of the blank. A part of the outer circumferential surface of the blank and a part of the inner circumferential surface of the blank are disconnected from a second portion of the metal sheet, while the other part of the outer circumferential surface of the blank and the other part of the inner circumferential surface of the blank are connected with the second portion of the metal sheet. In the separating stage, the blank is separated from the second portion of the metal sheet by disconnecting the other parts of the inner and outer circumferential surfaces of the blank from the second portion of the metal sheet to obtain the blank having a plurality of teeth formed in the tooth profile on at least one of the inner and outer circumferential surfaces as the gear.

With these stages of the method, in the separating stage, the blank having parts of the inner and outer circumferential surfaces already disconnected from the metal sheet is separated from the metal sheet by disconnecting the other parts of the inner and outer circumferential surfaces of the blank from the metal sheet. In this separation, the blank receives a shearing force. However, this shearing force is small as compared with that received in a blank fully connected with the metal sheet when the blank is disconnected from the metal sheet.

Accordingly, because the shearing force received in the blank is small, the gear can have a high flatness without being substantially warped, and burrs formed on the inner and outer circumferential surfaces of the blank during the separation can be made small. Further, because the gear is not substantially warped, the teeth can be formed on at least one of the inner or outer circumferential surface of the blank with a high precision.

Further, when the inner and outer circumferential surfaces of the blank are disconnected from the metal sheet in the separating stage, the moving directions of the inner and outer circumferential surfaces of the blank from the metal sheet are necessarily the same. Therefore, burrs formed on the inner circumferential surface of the blank in the separating stage and burrs formed on the outer circumferential surface of the blank in the separating stage are placed on the same side surface of the blank. When the side surface of the gear having the burrs is put on a side surface of a fixed disc to perform a break-in rotation of the gear on the side surface of the fixed disc, only the burrs stand on the side surface of the fixed disc. Therefore, after the break-in rotation, the burrs can be smoothly sunk into the fixed disc.

Accordingly, this method can reliably manufacture a gear superior in the meshing performance at a high flatness without any process for removing the burrs.

According to a third aspect of this invention, the object is achieved by the provision of a gear which is manufacturing by a first method according to the first aspect or a second method according to the second aspect. The gear has a plurality of teeth formed in the first or second profile on the outer or inner circumferential surface or formed in the tooth profile on the outer or inner circumferential surface.

With this structure of the gear, the gear can have a high flatness. Further, the gear can have the teeth shaped with a high precision.

### BRIEF DESCRIPTION OF THE DRAWINGS

FIG. 1 is a top view of a long metal sheet fed to a press to show stages of a conventional method of manufacturing rotary discs;

FIG. 2A is a sectional view of a part of a rotary disc with burrs just placed between two fixed discs;

FIG. 2B is a sectional view of a part of a rotary disc after performing the break-in rotation for the rotary disc placed between the fixed discs;

FIG. 3A is a sectional view of a blank produced from a metal sheet in a half blanking stage of a method of manufacturing a rotary disc according to the first embodiment of the present invention;

FIG. 3B is a sectional view of the blank punched in a punching stage in a punching stage of the method according to the first embodiment;

FIG. 3C is a sectional view of the blank obtained as a rotary disc in a separating stage of the method according to the first embodiment;

FIG. 4A is a plan view of the rotary disc manufactured by the method shown in FIGS. 3A to 3C;

FIG. 4B is a longitudinal sectional view taken substantially along line A-A of FIG. 4A;

FIG. 5A is a sectional view of a part of the rotary disc with burrs just placed between two fixed discs;

FIG. 5B is a sectional view of a part of the rotary disc after performing the break-in rotation for the rotary disc placed between the fixed discs;

FIG. 6A is a sectional view of a blank produced from a metal sheet in a half blanking stage of a method of manufacturing a rotary disc according to the second embodiment of the present invention;

FIG. 6B is a sectional view of the blank obtained as a rotary disc in a separating stage of the method according to the second embodiment;

FIG. 7A is a sectional view of a blank formed in a half blanking stage of a manufacturing method according to the third embodiment of the present invention;

FIG. 7B is a view, partially in cross-section, of the blank and punches of a press in a pressing force applying stage of the method according to the third embodiment;

FIG. 7C is a sectional view of the blank blanked out in a separating stage of the method according to the third embodiment;

FIG. 7D is an explanatory view showing the removal of warp from the blank in the pressing force applying stage shown in FIG. 7B;

FIG. 8 is a sectional view of a part of a blank for which coining is performed in the pressing force applying stage of the method according to the fourth embodiment; and

FIG. 9 is a sectional view of a part of a blank for which finish blanking is performed in a finish blanking stage of a manufacturing method according to the fifth embodiment.

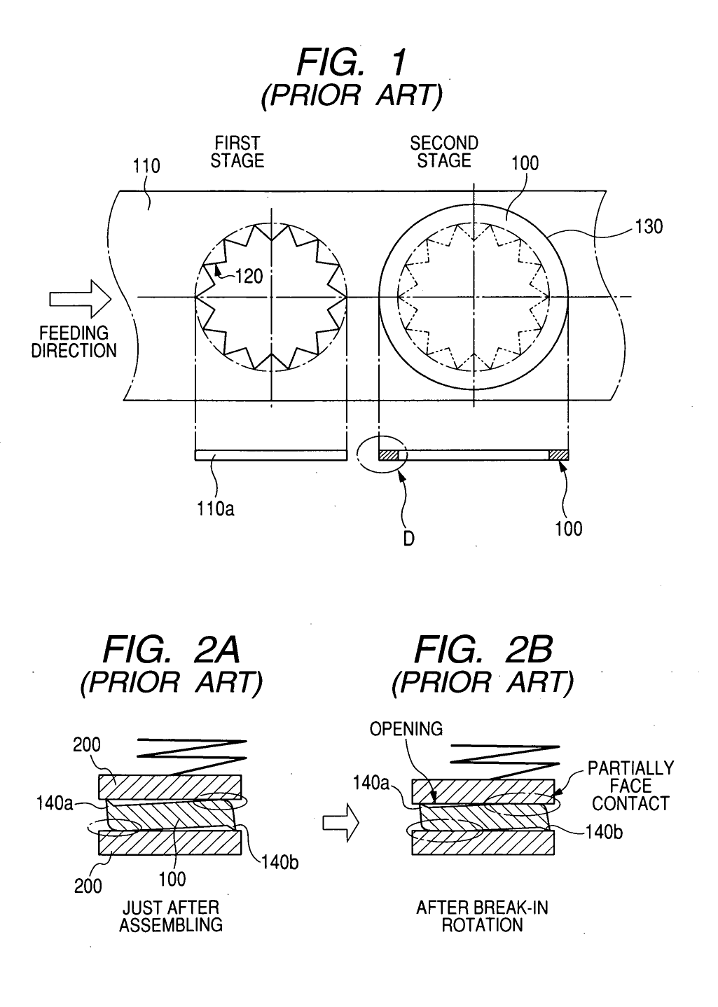

### DETAILED DESCRIPTION OF THE PREFERRED EMBODIMENTS

Embodiments of the present invention will now be described with reference to the accompanying drawings, in which like reference numerals indicate like parts, members or elements throughout the specification unless otherwise indicated.

### Embodiment 1

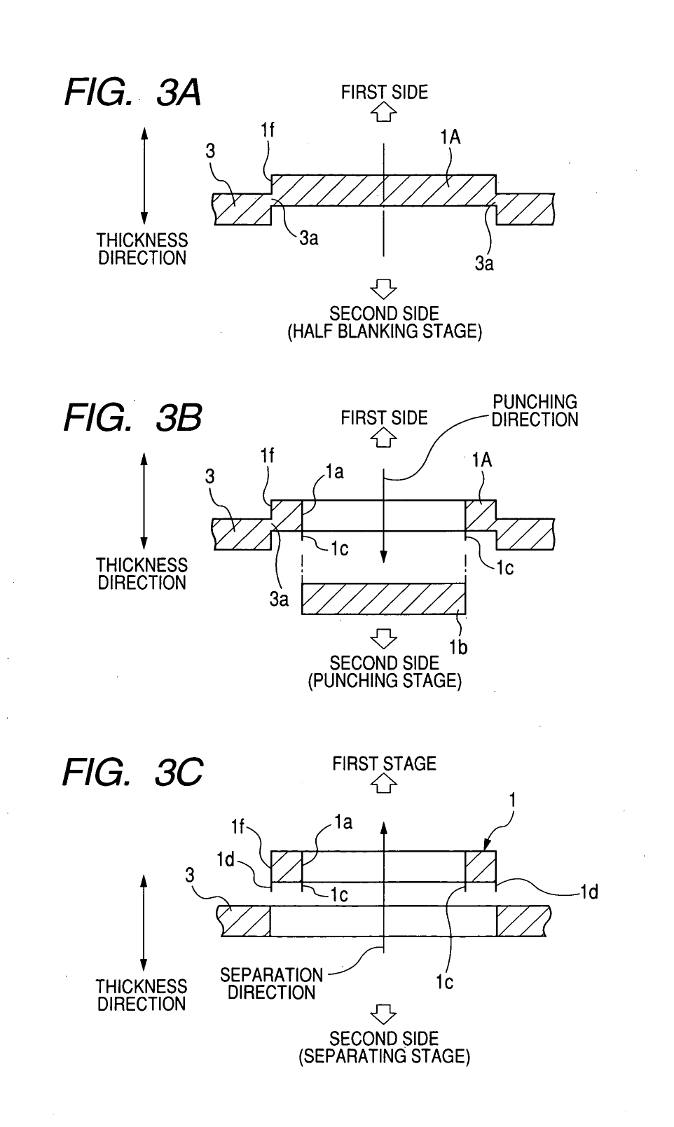

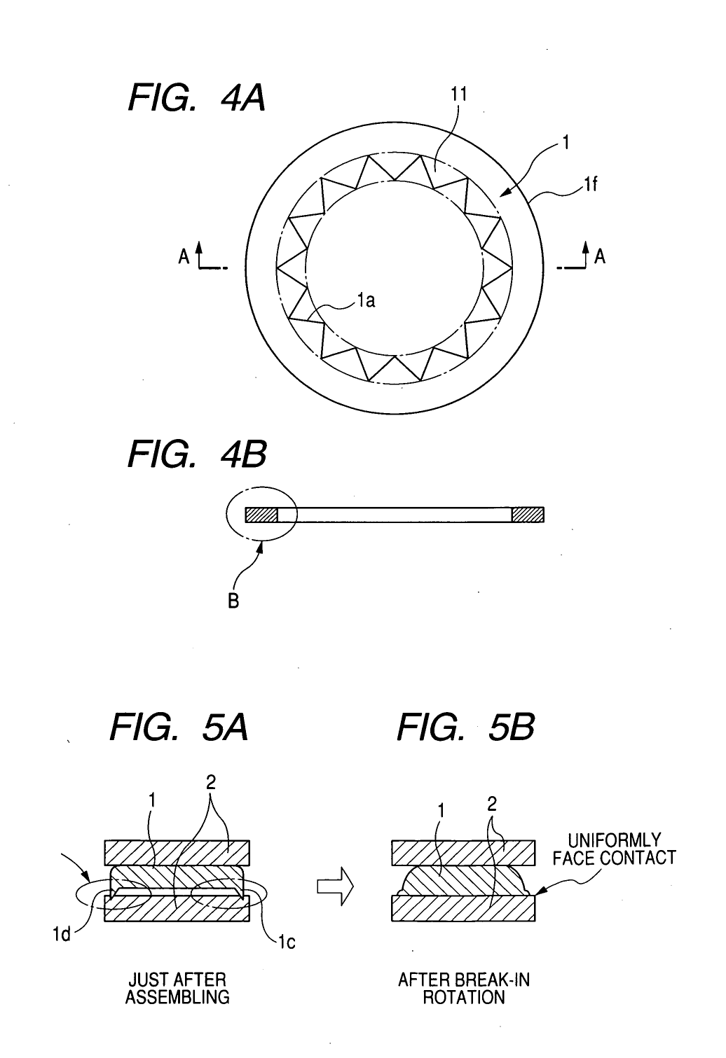

FIG. 3A is a sectional view of a blank produced from a metal sheet in a half blanking stage of a method of manufacturing a rotary disc according to the first embodiment of the present invention. FIG. 3B is a sectional view of the blank punched in a punching stage of the method according to the first embodiment. FIG. 3C is a sectional view of the blank obtained as a rotary disc in a separating stage of the method according to the first embodiment. FIG. 4A is a plan view of the rotary disc manufactured by the method shown in FIGS. 3A to 3C, while FIG. 4B is a longitudinal sectional view taken substantially along line A-A of FIG. 4A. FIG. 5A is a partial sectional view of the rotary disc with burrs just placed between two fixed discs, while FIG. 5B is a partial sectional view of the rotary disc after performing the break-in rotation for the rotary disc placed between the fixed discs. The view of the rotary disc in each of FIG. 5A and FIG. 5B is obtained by enlarging a portion B shown in FIG. 4B.

A gear manufactured by a method according to the present invention is represented by each of a plurality of rotary discs which form an internal gear of a speed reducing device. The internal gear meshes with a plurality of planet gears to reduce the rotational speed of a rotational force produced in a motor of a starter and to transmit the rotational force to an engine of a vehicle.

As shown in FIG. 4A and FIG. 4B, a rotary disc 1 made of steel or the like is formed in a ring shape to have a plurality of teeth 11 formed in a tooth profile la on the inner circumferential surface of the disc 1 and to have a circular profile if on the outer circumferential surface of the disc 1.

As shown in FIG. 5A and FIG. 5B, the rotary disc 1 is placed between two fixed discs 2 disposed on respective side surfaces of the disc 1 to be in contact with the fixed discs 2. The disc 1 has a frictional resistance with the discs 2, so that the discs 2 restrict the rotation of the disc 1 by the frictional resistance. Therefore, a rotational force produced in a motor is transmitted to an engine through the internal gear. In contrast, when a large rotational force is excessively applied as an impact to a torque transmission section of the starter from the engine, the rotary disc 1 is slid or rotated on the fixed discs 2 against the frictional resistance with the discs 2. Therefore, the internal gear having the rotary discs 1 absorbs the impact to interrupt the transmission of the impact.

The rotary disc 1 is manufactured in a half blanking (or half die cutting) stage, a punching stage and a separating stage serially performed in that order according to a manufacturing method.

As shown in FIG. 3A, in the half blanking stage, the half blanking is performed for a columnar portion of a metal sheet 3 made of steel or the like to produce a blank 1A with an outer circumferential surface from the columnar portion of the sheet 3 and to form or stamp the circular profile 1f on the outer circumferential surface of the blank 1A.

More specifically, a press (not shown) does not completely blank out the blank 1A from the sheet 3, but the press applies a shearing force to the sheet 3 to shift the columnar portion of the sheet 3 from the other portion of the sheet 3 toward the first side (e.g.,upper side in FIG. 3A) in the thickness direction of the sheet 3 by a shifting length shorter than the thickness of the sheet 3. The columnar portion of the sheet 3 is still connected with the other portion of the sheet 3. Therefore, the columnar portion of the sheet 3 is projected as the blank 1A toward the first side. A first side surface of the blank 1A faces the first side, and a second side surface of the blank 1A faces the second side opposite to the first side.

In this half blanking, a part of the outer circumferential surface of the blank 1A is disconnected from the other portion of the sheet 3, and the circular profile 1f is formed on the part of the outer circumferential surface of the blank 1A. A ring-shaped connecting surface 3a denoting the other part of the outer circumferential surface of the blank 1A is connected with the other portion of the sheet 3. For example, the width of the connecting surface 3a in the thickness direction is equal to or shorter than one-third of the thickness of the sheet 3.

Further, because the press is not required to completely blank out the blank 1A from the sheet 3, the shearing force required in the press working is small as compared with that required in the press when the press completely blanks out a blank from the metal sheet 3.

As shown in FIG. 3B, in the punching stage, the press punches an inner portion of the blank 1A in a punching direction (e.g. lower direction in FIG. 3B) directed from the first side of the blank 1A to the second side of the blank 1A to form or stamp the tooth profile 1a on an inner circumferential surface of the blank 1A.

More specifically, a first die of the press is put on the second side surface of the blank 1A, and the press having a first punch shaped in the tooth profile 1a punches an inner portion 1b of the blank 1A while moving the first punch in the punching direction. Therefore, the press cuts out the inner portion 1b in the blank 1A to form a hole in the blank 1A and to form an inner circumferential surface of the blank 1A facing the hole. A plurality of teeth 11 formed in the tooth profile 1a are placed on the inner circumferential surface of the blank 1A.

In this punching, first burrs 1c extending from the inner circumferential surface of the blank 1A are formed on the second side surface of the blank 1A. Further, the inner circumferential surface of the blank 1A punched receives a shearing force from the press. Therefore, the portion 1b cut off from the sheet 3 is easily warped. However, because the blank 1A is always supported by the die, the blank 1A cut off from the portion 1b resists being warped, so that the blank 1A maintains the high flatness.

As shown in FIG. 3C, in the separating stage, the blank 1A is separated as a rotary disc 1 from the other portion of the metal sheet 3 toward a separation direction opposite to the punching direction by disconnecting the connecting surface 3a of the blank 1A from the other portion of the metal sheet 3.

More specifically, a second die of the press is put on one surface of the sheet 3 facing the first side, and the press having a second punch blanks out the blank 1A while moving the second punch in the separation direction to disconnect the connecting surface 3a of the blank 1A from the sheet 3. Therefore, the blank 1A having the circular profile 1f on its outer circumferential surface is moved toward the separation direction and is cut off from the sheet 3 as the rotary disc 1.

In this separation, second burrs 1d extending from the outer circumferential surface of the disc 1 are formed on the second side surface of the disc 1 facing the second side. Because the punching direction and the separation direction are opposite to each other, the first and second burrs 1c and 1d are placed on the same side surface of the disc 1.

Further, the outer circumferential surface of the blank 1A receives a shearing force from the press, so that the blank 1A is blanked out from the sheet 3. However, because only the connecting surface 3a of the blank 1A is disconnected from the sheet 3 in the separation, the shearing force applied to the outer circumferential surface of the blank 1A is small. That is, the shearing force required in the press is small as compared with that required in the press when the whole outer circumferential surface of the blank 3 is disconnected at once from the sheet 3.

Thereafter, as shown in FIG. 5A, each of a plurality of rotary discs 1 manufactured according to the method is disposed between two fixed discs 2, so that a rotary gear having the rotary discs 1 is assembled. The side surfaces of the rotary disc 1 are in contact with side surfaces of the fixed discs 2. Each disc 2 is made of phosphor bronze (Cu—Sn—P alloy), so that the hardness of the disc 2 is lower than that of the disc 1 made of steel. Because the first and second burrs 1c and 1d are placed on the same side surface of the disc 1, the disc 1 is in face contact with one fixed disc 2 and is in point contact with the other fixed disc 2. Then, as shown in FIG. 5B, the break-in rotation is performed for the rotary disc 1. Because the hardness of the disc 2 is lower than that of the disc 1, the burrs 1c and 1d are sunk into the discs 2 during the break-in rotation. Finally, the rotary disc 1 is in face contact with each of the fixed discs 2.

As is described above, in the manufacturing method according to this embodiment, the half blanking is performed for a first portion of the metal sheet 3 to produce the blank 1A with an outer circumferential surface facing the other portion of the sheet 3 from the first portion of the sheet 3 and to form the circular profile 1f on the outer circumferential surface of the blank 1A. A part of the outer circumferential surface of the blank 1A is disconnected from the second portion of the sheet 3 while a connecting surface 3a denoting the other part of the outer circumferential surface of the blank 1A is connected with the other portion of the sheet 1. Then, the inner portion 1b of the blank 1A is punched in the punching direction to form an inner circumferential surface of the blank 1A and to form the inner circumferential surface of the blank in the tooth profile 1a. Then, the blank 1A is separated from the other portion of the sheet 3 toward the separation direction opposite to the punching direction by disconnecting the connecting surface 3a of the blank 1A from the other portion of the sheet 3. Therefore, the blank 1A separated is used as one rotational disc 1 having the teeth 11 on the inner circumferential surface.

With these stages of the method, because only the connecting surface 3a of the blank 1A still connected with the sheet 3 is cut off and disconnected from the sheet 3 in the separation stage, the shearing force applied to the blank 1A in the separation stage can be reduced. Accordingly, because the shearing force applied to the rotary disc 1 is reduced, the warp caused in the disc 1 can be reduced, and the second burrs 1d formed on the outer circumferential surface of the disc 1 can become small. Because the disc 1 not warped has a high flatness, the teeth 11 can be formed on the inner circumferential surface of the disc 1 with high precision.

Further, the shearing force required for the press in the separation stage is reduced. Accordingly, even when a widely-used mechanical press different from a hydraulic press being expensive and used for a specific purpose is used to manufacture the disc 1, the disc 1 can be manufactured according to the method so as to have a high flatness and the tooth profile 1a precisely formed.

Moreover, because the punching direction in the punching stage is opposite to the separation direction (i.e., punching direction of the second punch) in the separation stage, the first and second burrs 1c and 1d are placed on the same side of the disc 1. Therefore, as shown in FIG. 5A, when the rotary disc 1 is placed between two fixed discs 2, one side surface of the disc 1 having no burrs can be uniformly in face contact with one side surface of one fixed disc 2. In contrast, just after the disc 1 is placed between the fixed discs 2, the other side surface of the disc 1 having the first and second burrs 1c and 1d is in point contact with one side surface of the other fixed disc 2. Therefore, an opening is formed between the disc 1 and the other fixed disc 2. However, as shown in FIG. 5B, after the break-in operation for the rotary disc 1, the disc 1 and the other fixed disc 2 can be uniformly in contact with each other. The reason is as follows. The hardness of the disc 1 is higher than that of the disc 2. Therefore, the burrs 1c and 1d of the disc 1 are sunk into the disc 2 during the break-in rotation.

Accordingly, no process for removing the burrs 1c and 1d from the disc 1 is required after the separation of the disc 1 from the sheet 3. Further, no process for flattening the disc 1 is required. That is, the disc 1 being superior in the meshing performance and having a high flatness can be manufactured only in the press working composed of the half blanking stage, the punching stage and the separation stage of the method by using the mechanical press, and the productivity of discs 1 can be improved.

### Embodiment 2

In the first embodiment, the punching stage and the separating stage are independently performed. However, the punching stage and the separating stage may be simultaneously performed.

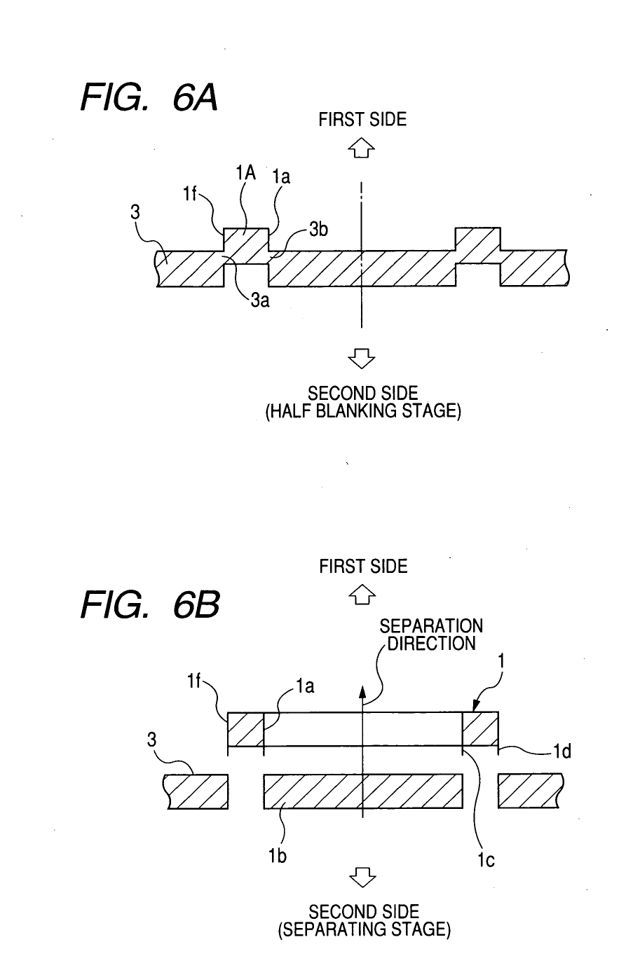

FIG. 6A is a sectional view of a blank produced from a metal sheet in a half blanking stage of a method according to the second embodiment, and FIG. 6B is a sectional view of the blank obtained as a rotary disc in a separating stage of the method according to the second embodiment.

In this method, a half blanking stage and a separating stage are performed in that order to manufacture the rotary disc 1.

As shown in FIG. 6A, in the half blanking stage, half blanking is performed for a first portion of the metal sheet 3 to produce a blank 1A with an outer circumferential surface and an inner circumferential surface from the first portion of the sheet 3 and to form the tooth profile 1a on the inner circumferential surface of the blank 1A. A part of the inner circumferential surface of the blank 1A and a part of the outer circumferential surface of the blank 1A are disconnected from the other portion of the sheet 3. The tooth profile 1a is formed on the part of the inner circumferential surface of the blank 1A. The circular profile 1f is formed on the part of the outer circumferential surface of the blank 1A. A first ring-shaped connecting surface 3a denoting the other part of the outer circumferential surface of the blank 1A and a second ring-shaped connecting surface 3b denoting the other part of the inner circumferential surface of the blank 1A are still connected with the other portion of the sheet 3. For example, the width of each of the connecting surfaces 3a and 3b in the thickness direction is equal to or shorter than one-third of the thickness of the sheet 3.

More specifically, in this half blanking, a press (not shown) does not completely blank out the blank 1A from the sheet 3, but the press shifts a cylindrical portion of the sheet 3 from the other portion of the sheet 3 toward the first side (e.g., upper side in FIG. 3A) in the thickness direction of the sheet 3 by a shifting length shorter than the thickness of the sheet 3. Therefore, the cylindrical portion of the sheet 3 is connected with the other portion of the sheet 3. Therefore, the cylindrical portion of the sheet 3 is projected as the blank 1A toward the first side while the blank 1A is still connected with the other portion of the sheet 3. Further, the press forms or stamps the tooth profile 1a on the inner circumferential surface of the blank 1A, and forms or stamps the circular profile 1f on the outer circumferential surface of the blank 1A.

As shown in FIG. 6B, in the separating stage, the blank 1A is separated as a rotary disc 1 from the other portion of the metal sheet 3 in a separation direction directed from the second side to the first side of the sheet 3 by disconnecting the connecting surfaces 3a and 3b of the blank 1A from the other portion of the metal sheet 3.

More specifically, a die of the press is placed on one surface of the sheet 3 on the first side, and the press having a ring-shaped punch completely blanks out the blank 1A while moving the punch in the separation direction to simultaneously disconnect the connecting surfaces 3a and 3b of the blank 1A from the sheet 3. Therefore, the blank 1A having the circular profile if on its outer circumferential surface and the tooth profile 1a on its inner circumferential surface is cut off from the sheet 3 as the rotary disc 1.

In this separating stage, because the connection surfaces 3a and 3b are moved in the separation direction to be separated from the sheet 3, first burrs 1c extending from the inner circumferential surface of the disc 1 and second burrs 1d extending from the outer circumferential surface of the disc 1 are formed on the same side surface of the disc 1 facing the first side.

Further, in the separating stage, each of the inner and outer circumferential surfaces of the disc 1 receives a shearing force from the press. However, because only the connecting surface 3a in the outer circumferential surface of the disc 1 is disconnected from the sheet 3, the shearing force applied to the outer circumferential surface of the disc 1 is small. Further, because only the connecting surface 3b in the inner circumferential surface of the disc 1 is disconnected from the sheet 3, the shearing force applied to the inner circumferential surface of the disc 1 is small.

Thereafter, as shown in FIG. 5A and FIG. 5B, the disc 1 is placed between two fixed discs 2, and the break-in rotation is performed for the disc 1. Therefore, in the same manner as in the first embodiment, the disc 1 is in face contact with each of the fixed discs 2.

As is described above, in this method, the half blanking is performed for the metal sheet 3 to produce the blank 1A from a cylindrical portion of the sheet 3 and to form the tooth profile 1a on the blank 1A. That is, a part of the outer circumferential surface of the blank 1A and a part of the inner circumferential surface of the blank 1A are disconnected from the other portion of the sheet 1 while the other part of the outer circumferential surface of the blank 1A and the other part of the inner circumferential surface of the blank 1A are still connected with the other portion of the sheet 3, and the tooth profile 1a is formed or stamped on the part of the inner circumferential surface of the blank 1A. Thereafter, the blank 1A is separated from the other portion of the sheet 3 by disconnecting the other parts of the inner and outer circumferential surfaces of the blank 1A from the other portion of the sheet 3 to obtain the blank 1A having the teeth 11 formed in the tooth profile 1a on the inner circumferential surface as the rotary disc 1.

Because only the connection surfaces 3a and 3b of the blank 1A are disconnected from the sheet 3 in the separating stage, the shearing force required to blank out the rotary disc 1 from the sheet 3 can be reduced. Therefore, the rotary disc 1 can have a high flatness, and a mechanical press can be used for the method. Further, because the burrs 1c and 1d are formed on the same side surface of the rotary disc 1, each side surface of the rotary disc 1 can be uniformly in contact with one side surface of the corresponding fixed disc 2 after the break-in rotation.

Accordingly, no process for removing the burrs 1c and 1d from the disc 1 is required after the separation of the disc 1 from the sheet 3. Further, no process for flattening the disc 1 is required. That is, the disc 1 superior in the meshing performance can be manufactured at a high flatness only in the press working composed of the half blanking stage and the separation stage of the method by using the mechanical press, and the productivity of discs 1 can be improved.

Further, as compared with the method according to the first embodiment, because the inner and outer circumferential surfaces of the disc 1 are simultaneously disconnected from the sheet 3, no punching stage is required. Accordingly, the manufacturing method can be simplified.

### Embodiment 3

In the second embodiment, because the blank 1A produced in the half blanking stage receives a pressing force only from one side of the blank 1A, the side surfaces of the blank 1A are sometimes warped in the thickness direction of the blank 1A. In the manufacturing method according to the third embodiment, a pressing force applying stage is additionally performed to remove this warp of the blank 1A.

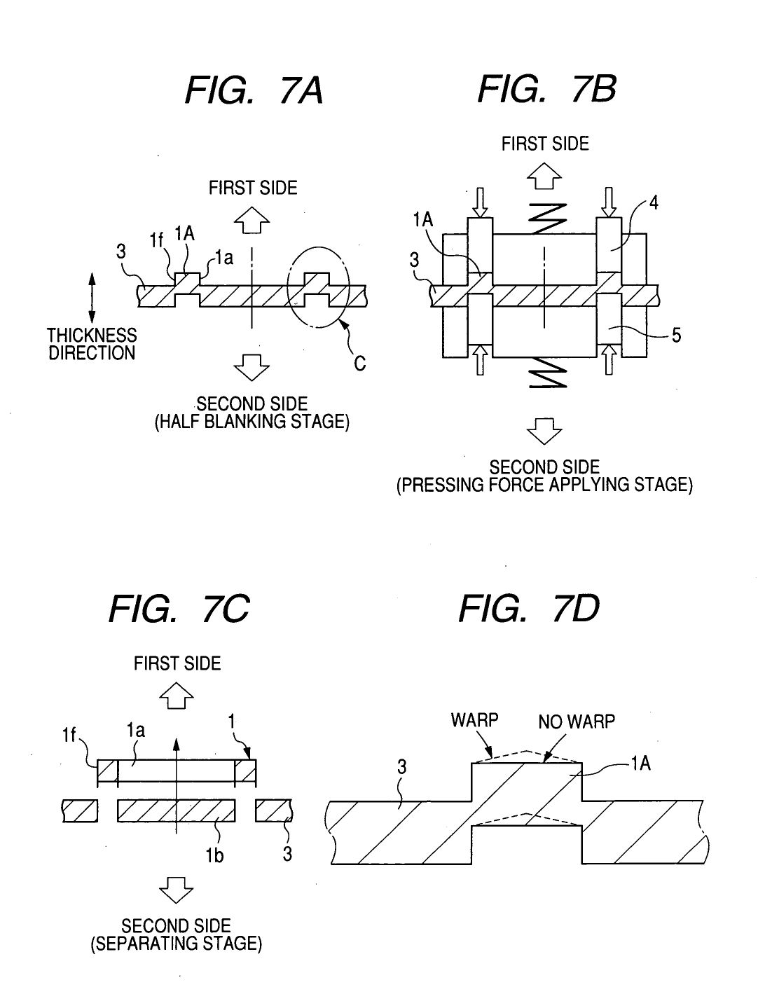

FIG. 7A is a sectional view of a blank formed in a half blanking stage of a manufacturing method according to the third embodiment. FIG. 7B is a view, partially in cross-section, of the blank and punches of a press in a pressing force applying stage of the method. FIG. 7C is a sectional view of the blank blanked out as a rotary disc in a separating stage of the method. FIG. 7D is an explanatory view showing the removal of warp from the blank in the pressing force applying stage.

In this method, a half blanking stage, a pressing force applying stage and a separation stage are performed in that order to manufacture the rotary disc 1. The half blanking stage and the separation stage shown in FIG. 7A and FIG. 7C are performed in the same manner as those in the second embodiment.

As shown in FIG. 7B, in the pressing force applying stage, a first metal mold of a press such as a first punch 4 formed in a ring shape is attached to the first side surface of the blank 1A facing the first side, and a second metal mold of the press such as a second punch 5 formed in a ring shape is attached to the second side surface of the blank 1A facing the second side. Then, the press applies a high pressing force to the blank 1A through the punches 4 and 5 in the thickness direction of the blank 1A. Therefore, the punches 4 and 5 strongly press the side surfaces of the blank 1A, and the blank 1A receives the pressing force from each of both sides in the thickness direction.

In response to the pressing force, warp of the blank 1A is removed. More specifically, as shown by dotted lines of FIG. 7D, the side surfaces of the blank 1A are sometimes warped in the thickness direction in the half blanking stage. However, as shown by solid lines of FIG. 7D, the side surfaces of the blank 1A are flattened by the pressing force of the press. That is, the warp of the blank 1A is removed.

Accordingly, because the pressing force applying stage is performed between the half blanking stage and the separating stage, a rotary disc 1 set at a high flatness can be reliably manufactured in this method.

This pressing force applying stage may be performed for the method according to the first embodiment. For example, the pressing force applying stage is performed between the half blanking stage and the punching stage to remove the warp of the blank 1A sometimes caused in the half blanking, or the pressing force applying stage is performed between the punching stage and the separating stage to remove the warp of the blank 1A sometimes caused in the punching stage. Further, the pressing force applying stage may be performed between the half blanking stage and the punching stage and between the punching stage and the separating stage.

Moreover, the pressing force applying stage may be performed simultaneous with the half blanking stage. More specifically, the punches 4 and 5 are attached to respective side surfaces of a cylindrical portion of the sheet 3, and the half blanking is performed for the sheet 3 to produce a blank 1A from the cylindrical portion while the press applies a high pressing force to the blank 1A through the punches 4 and 5. In this method, the manufacturing of the rotary disc 1 can be simplified.

### Embodiment 4

When the blank 1A receives a high pressing force in the pressing force applying stage, the blank 1A sometimes has residual stress caused by the pressing force in its internal portion. In the fourth embodiment, this residual stress is removed from the blank 1A.

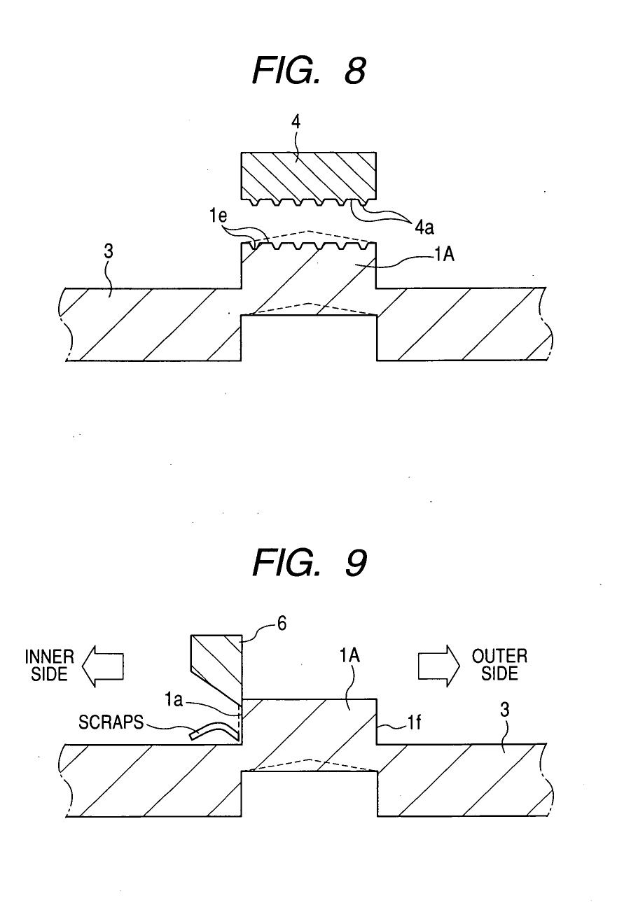

FIG. 8 is a sectional view of a part of a blank for which coining is performed in the pressing force applying stage of the method according to the fourth embodiment.

As shown in FIG. 8, when the press applies a pressing force to the blank 1A through the punches 4 and 6 in the pressing force applying stage (see FIG. 7B), coining is simultaneously performed for the blank 1A. More specifically, the punch 4 has many bumps and/or dimples 4a on its surface. In the pressing force applying stage, the punch 4 is pressed onto the blank 1A produced in the half blanking stage so as to compress the first side surface of the blank 1A with the surface having the bumps and/or dimples 4a. Therefore, the pattern of the bumps and/or dimples 4a is transferred to the first side surface of the blank 1A, so that transferred dimples and bumps 1e having the transferred pattern are formed on the first side surface of the blank 1A. In this coining, the internal portion of the blank 1A receives a compressive stress based on the pressing force.

Accordingly, even when the residual stress is caused in the internal portion of the blank 1A in the half blanking stage or the punching stage, the compressive stress in the coining can effectively remove the residual stress of the blank 1A. Further, because the residual stress is removed, the warp of the side surfaces of the blank 1A can be further removed so as to improve the flatness of the rotary disc 1.

Moreover, when an internal gear having a plurality of rotary discs 1 is disposed in a starter, a space between each disc 1 and the adjacent fixed disc 2 is filled with lubricating oil such as grease. Because the lubricating oil is effectively held in the dimples and dumps 1e of the disc 1, the coining can effectively prevent seizure of the rotary disc 1 to the fixed disc 2.

### Embodiment 5

When the blank 1A is punched or blanked out in the punching stage or the half blanking stage, the tooth profile 1a is sometimes distorted, or shear droop is sometimes formed on the teeth 11 of the blank 1A. In the fifth embodiment, finish blanking is performed for the blank 1A to remove the distortion of the tooth profile 1a or the shear droops.

FIG. 9 is a sectional view of a part of a blank for which finish blanking is performed in a finish blanking stage of a manufacturing method according to the fifth embodiment.

In this method, the half blanking stage, the punching stage, the finish blanking stage and the separation stage is performed in that order, or the half blanking stage, a finish blanking stage and the separation stage are performed in that order.

As shown in FIG. 9, in the finish blanking stage, finish blanking is performed for the blank 1A to finish up the teeth 11 of the blank 1A. More specifically, the press has a finish punch 6, and the finish punch 6 removes the distortion and/or shear droop formed on the teeth 11 of the tooth profile 1a.

Accordingly, the rotary disc 1 can have the teeth 11 with a higher precision.

In this embodiment, the finish blanking is performed for the blank 1A before the separating stage. However, the finish blanking may be performed simultaneous with the separating stage.

### Modifications

In the first and second embodiments, the teeth 11 having the tooth profile 1a are formed on the inner circumferential surface of the rotary disc 1. However, the teeth 11 having the tooth profile 1a may be formed on the outer circumferential surface of the rotary disc 1. Further, a plurality of teeth having a first tooth profile may be formed on the inner circumferential surface of the rotary disc 1, while a plurality of teeth having a second tooth profile are formed on the outer circumferential surface of the rotary disc 1.

For example, in the half blanking stage according to the first and second embodiments (see FIG. 3A and FIG. 6A), the tooth profile 1a is formed on the outer circumferential surface of the blank 1A.

These embodiments should not be construed as limiting the present invention to structures of those embodiments, and the structure of this invention may be combined with that based on the prior art.

What is claimed is:

1. A method of manufacturing a gear, comprising the steps of:
performing half blanking for a first portion of a metal sheet to produce a blank with an outer circumferential surface facing a second portion of the metal sheet from the first portion of the metal sheet and to form a first profile on the outer circumferential surface of the blank, wherein a part of the outer circumferential surface of the blank is disconnected from the second portion of the metal sheet while the other part of the outer circumferential surface of the blank is connected with the second portion of the metal sheet;
punching an inner portion of the blank in a punching direction to form an inner circumferential surface of the blank and to form the inner circumferential surface of the blank in a second profile, wherein at least one of the first and second profiles is a profile of a plurality of teeth to form the blank having the teeth on its inner or outer circumferential surface; and
separating the blank from the second portion of the metal sheet as the gear toward a separation direction opposite to the punching direction by disconnecting the other part of the outer circumferential surface of the blank from the second portion of the metal sheet.

2. The method according to claim 1, wherein the step of performing the half blanking includes:
shifting the first portion of the metal sheet from the second portion of the metal sheet as the blank toward a first side in a thickness direction of the metal sheet while applying a pressing force to a first surface of the blank facing the first side and applying another pressing force to a second surface of the blank facing a second side opposite to the first side.

3. The method according to claim 2, wherein the step of performing the half blanking further includes:
forming bumps or dimples on a surface of a metal mold;
pressing the metal mold onto the first or second surface of the blank, while applying the pressing force to the first or second surface of the blank, to compress the first or second surface of the blank with the surface of the metal mold having the bumps or dimples; and
transferring a pattern of the bumps or dimples to the first or second surface of the blank.

4. The method according to claim 1, further comprising the step of applying a pressing force to each of first and second surfaces of the blank facing respective sides in a thickness direction of the metal sheet after the step of the half blanking and before the step of punching the blank.

5. The method according to claim 4, wherein the step of applying the pressing force includes:
forming bumps or dimples on a surface of a metal mold;
pressing the metal mold onto the first or second surface of the blank, while applying the pressing force to the first or second surface, to compress the first or second surface of the blank with the surface of the metal mold having the bumps or dimples; and
transferring a pattern of the bumps or dimples to the first or second surface of the blank.

6. The method according to claim 1, further comprising the step of applying a pressing force to each of first and second surfaces of the blank facing respective sides in a thickness direction of the metal sheet after the step of punching the blank and before the step of separating the blank.

7. The method according to claim 6, wherein the step of applying the pressing force includes:
forming bumps or dimples on a surface of a metal mold;
pressing the metal mold onto the first or second surface of the blank, while applying the pressing force to the first or second surface, to compress the first or second surface of the blank with the surface of the metal mold having the bumps or dimples; and
transferring a pattern of the bumps or dimples to the first or second surface of the blank.

8. The method according to claim 1, further comprising the step of performing finish blanking for the blank punched in the punching direction to finish up the teeth of the blank.

9. The method according to claim 1, wherein the step of separating the blank includes:
performing finish blanking for the blank to finish up the teeth of the blank.

10. The method according to claim 1, wherein the step of performing half blanking includes:
shifting the first portion of the metal sheet from the second portion of the metal sheet as the blank toward a first side in a thickness direction of the metal sheet, and the step of separating the blank include:
separating the blank from the second portion of the metal sheet toward the first side.

11. A method of manufacturing a gear, comprising the steps of:
performing half blanking for a first portion of a metal sheet to produce a blank with an outer circumferential surface and an inner circumferential surface from the first portion of the metal sheet and to form a tooth profile on at least one of the inner and outer circumferential surfaces of the blank, wherein a part of the outer circumferential surface of the blank and a part of the inner circumferential surface of the blank are disconnected from a second portion of the metal sheet while the other part of the outer circumferential surface of the blank and the other part of the inner circumferential surface of the blank are connected with the second portion of the metal sheet; and
separating the blank from the second portion of the metal sheet by disconnecting the other parts of the inner and outer circumferential surfaces of the blank from the second portion of the metal sheet to obtain the blank having a plurality of teeth formed in the tooth profile on at least one of the inner and outer circumferential surfaces as the gear.

12. The method according to claim 11, wherein the step of performing half blanking includes:
shifting the first portion of the metal sheet from the second portion of the metal sheet as the blank toward a first side in a thickness direction of the metal sheet while applying a pressing force to a first surface of the blank facing the first side and applying another pressing force to a second surface of the blank facing a second side opposite to the first side.

13. The method according to claim 12, wherein the step of performing half blanking further includes:
forming bumps or dimples on a surface of a metal mold;
pressing the metal mold onto the first or second surface of the blank, while applying the pressing force to the first or second surface, to compress the first or second surface of the blank with the surface of the metal mold having the bumps or dimples; and
transferring a pattern of the bumps or dimples to the first or second surface of the blank.

14. The method according to claim 11, further comprising a step of applying a pressing force to each of surfaces of the blank facing respective sides in a thickness direction of the metal sheet after the step of the half blanking and before the step of separating the blank.

15. The method according to claim 14, wherein the step of applying the pressing force includes:
forming bumps or dimples on a surface of a metal mold;
pressing the metal mold onto one of the surfaces of the blank, while applying the pressing force to the surface of the blank, to compress the surface of the blank with the surface of the metal mold having the bumps or dimples; and
transferring a pattern of the bumps or dimples to the surface of the blank.

16. The method according to claim 11, further comprising the step of performing finish blanking for the blank, not yet separated in the step of separating the blank, to finish up the teeth of the blank.

17. The method according to claim 11, the step of separating the blank includes:
performing finish blanking for the blank to finish up the teeth of the blank.

18. The method according to claim 11, wherein the step of performing half blanking includes:
shifting the first portion of the metal sheet from the second portion of the metal sheet as the blank toward a first side in a thickness direction of the metal sheet, and the step of separating the blank include:
separating the blank from the second portion of the metal sheet toward the first side.

19. A gear which is manufacturing by a first method comprising the steps of:
performing half blanking for a first portion of a metal sheet to produce a blank with an outer circumferential surface facing a second portion of the metal sheet from the first portion of the metal sheet and to form a first profile on the outer circumferential surface of the blank, wherein a part of the outer circumferential surface of the blank is disconnected from the second portion of the metal sheet while the other part of the outer circumferential surface of the blank is connected with the second portion of the metal sheet;
punching an inner portion of the blank in a punching direction to form an inner circumferential surface of the blank and to form the inner circumferential surface of the blank in a second profile; and
separating the blank from the second portion of the metal sheet as the gear toward a separation direction opposite to the punching direction by disconnecting the other part of the outer circumferential surface of the blank from the second portion of the metal sheet, or which is manufacturing by a second method comprising the steps of:
performing half blanking for a first portion of a metal sheet to produce a blank with an outer circumferential surface and an inner circumferential surface from the first portion of the metal sheet and to form a tooth profile on at least one of the inner and outer circumferential surfaces of the blank, wherein a part of the outer circumferential surface of the blank and a part of the inner circumferential surface of the blank are disconnected from a second portion of the metal sheet while the other part of the outer circumferential surface of the blank and the other part of the inner circumferential surface of the blank are connected with the second portion of the metal sheet; and
separating the blank from the second portion of the metal sheet as the gear by disconnecting the other parts of the inner and outer circumferential surfaces of the blank from the second portion of the metal sheet, the gear comprising:
a plurality of teeth formed in the first or second profile on the outer or inner circumferential surface or formed in the tooth profile on the outer or inner circumferential surface.

20. The gear according to claim 19, further comprising a surface which is in contact with a surface of a fixed disc while having a frictional resistance between the surface of the gear and the surface of the fixed disc.
